(19) United States
(12) Patent Application Publication
(10) Pub. No.: US 2008/0190140 A1
(43) Pub. Date: Aug. 14, 2008

(54) Method for manufacturing anti-microbial glass particles

(75) Inventor: Harald Selig, Dessau (DE)

Correspondence Address: LERNER GREENBERG STEMER LLP, P O BOX 2480, HOLLYWOOD, FL, 33022-2480, US

(73) Assignee: Trovotech GmbH

(21) Appl. No.: 11/594,492

(22) Filed: Nov. 8, 2006

Related U.S. Application Data
(63) Continuation of application No. PCT/EP05/03770, filed on Apr. 11, 2005.

(30) Foreign Application Priority Data
May 8, 2004 (DE) 10 2004 022 779.9

(51) Int. Cl. C03B 19/08; C03B 19/00

(52) U.S. Cl. 65/22; 65/85

(57) ABSTRACT

A method for manufacturing anti-microbial glass particles where anti-microbial glasses or known substances for anti-microbial glasses are melted, broken or pulverized and put into an extruder in this form. In addition, heavy metals or other anti-microbial effective substances are put into the extruder, where they are melted or smelted and mixed with the anti-microbial glass and, after cooling, the additionally added heavy metals or other anti-microbial effective substances are present in the anti-microbial glass in crystalline or in the original condition, whereby they are enveloped and evenly distributed.

### CROSS-REFERENCE TO RELATED APPLICATION

This is a continuing application, under 35 U.S.C. §120, of copending international application PCT/EP2005/003770, filed Apr. 11, 2005, which designated the United States; this application also claims the priority, under 35 U.S.C. §119, of German patent application DE 10 2004 022 779.9, filed May 8, 2004; the prior applications are herewith incorporated by reference in their entirety.

### BACKGROUND OF THE INVENTION

### Field of the Invention

The invention relates to a method for manufacturing minutely small microbial glass particles.

Glasses with anti-microbial or anti-bacterial effects are applied in the fields of cosmetics, in medical products or specimens, in synthetic materials or polymers, in the paper industry, for the conservation of paints, lacquers and surface plastering or deodorant production in cleaning agents, for disinfection or similar.

Glasses having an anti-microbial or anti-bacterial effect are known to an adequate degree and they exist in numerous formulations. Among other causes, the anti-microbial or anti-bacterial effect is attributable here to the release of metal ions. For example, alkaline ions can be exchanged which increase the pH-value and have an osmotic effect on micro-organisms. Furthermore, copper and zinc as well as silver are selectable as releasing metal ions with an anti-microbial or anti-bacterial effect.

However, other heavy metal ions also show a synergetic boosting of the anti-bacterial effect.

In this case it must be considered that disadvantages are to be expected, depending of the individual volume and type of the released metal ions.

The anti-microbial effect of the glass is obtained in some glasses by reactions at the surface of the glass, for example as described in published, non-prosecuted German patent application DE 103 13 630 A1.

In this case, alkalis of the glass are exchanged on the surface of the glass by H+-ions of the watery medium. The anti-microbial effect of the ion exchange is based, among other things, on an increase of the pH-value and the osmotic effect on micro-organisms.

In published, German patent application DE 101 41 117 A1, corresponding to U.S. patent disclosure No. 2005/0069592 A1, an anti-microbial and conserving silicate glass with a low-level heavy metal release is described.

In published, German patent application DE 101 41 230 A1, a glass as a color additive with an anti-microbial effect is described which has no toxicity for the human being and achieves at the same time a conservation of the paints and lacquers.

In U.S. Pat. No. 5,290,544, glasses for applications in cosmetic products are described. These glasses dissolve in water as a result of their chemical composition because they have a low SiO₂ and a high B₂O₃ or high P₂O₅ content. The Ag- and/or Cu-ions contained therein are released and have an anti-bacterial effect.

Anti-microbial glasses are also described in U.S. Pat. No. 6,143,318. These glasses have their anti-microbial effect because of the adopted copper, silver and zinc, among other things. However, based on their low-level hydrolytic durability, these anti-microbial glasses cannot be ground in watery media.

In published, German patent application DE 195 36 666 A1 and German patent DE 195 45 065 C2, methods are described where glasses are foamed up in an extruder with chemical propellants or gaseous additives. The foamed glass manufactured by this solution is used as a thermal insulating material.

The disadvantageous aspect with the technical solutions as described above is the fact that the particles for usage are not to be used in all fields of cosmetics, in medical products or specimens, in synthetic materials or polymers, in the paper industry, for the conservation of paints, lacquers and surface plastering or deodorant production in cleaning agents, for disinfection or similar, because the crushing ratio according to the state of the art for this usage is not always sufficient and/or the method products are envisaged for other applications and, for this reason, have no anti-microbial effect.

### SUMMARY OF THE INVENTION

It is accordingly an object of the invention to provide a method for manufacturing anti-microbial glass particles which overcomes the above-mentioned disadvantages of the prior art methods of this general type, which improves the known methods to such an extent and to such a way that the anti-microbial glass particles are transformed into minutely small particles.

With the foregoing and other objects in view there is provided, in accordance with the invention, a method for manufacturing anti-microbial glass particles. The method includes melting, breaking or pulverizing anti-microbial glasses or known substances for forming anti-microbial glasses resulting in a prepared composition of anti-microbial glass. The prepared composition of anti-microbial glass is put into an extruder. An additive, being either heavy metals or anti-microbial effective substances, are added into the extruder, where the additive is melted or smelted and mixed with the prepared composition of anti-microbial glass resulting in a melted anti-microbial glass mixture. The melted anti-microbial glass mixture is cooled resulting in an anti-microbial glass mixture, and after cooling the additive mixed in the anti-microbial glass mixture is crystalline or in an original condition, and the additive is enveloped and evenly distributed in the anti-microbial glass mixture.

The extraction of the metal or heavy metal ions as well as the exchange of the alkalis of the glass by H⁺-ions depends on the composition of the glass and the correlated solubility as well as its crushing process.

As a result of the crushing process the surface of the glass is increased which, in the end, influences the extraction of the metal ions. In this way, and by the method according to the invention, platelet-shaped anti-microbial glasses can be manufactured whose wall thickness lies in the micrometer range or particular small particles by a further grinding process. Platelet-shaped particles or particularly small particles therefore have particularly large surfaces also. These minutely small particles are then distributed in the final products, as finally shown by the anti-bacterial effect. The finer the distribution, the better the protection of the final product against a microbiological attack.

In the method according to the invention, it is shown how the anti-microbial glasses can be processed to minutely small particles with the use of known methods, whereby further anti-microbial active ingredients can be worked into the glass. The active ingredients can be chemically bound into the anti-microbial glass, can be dissolved or can be enveloped by the glass, e.g., as a filling material.

The basic glass, or the raw materials, required for the manufacture of the anti-microbial glass particles are melted down in a pressure-tight vessel, preferably an extruder. However, this melting is not limited according to the invention to the use of an extruder but can also be carried out in an autoclave.

The anti-microbial glass melt is mixed with one or several propellants, e.g., water or other media which dissolve under pressure in the anti-microbial glass melt.

The mixing effect of the microbial glass melt, which is under pressure, with the propellant can be intensified in an autoclave with the use of the method by stirring or blow-in of gases into the melt. This solution of the propellants can be affected chemically and physically. The foam is formed in a follow-up pressure reduction.

The structure of the foam depends on the pressure ahead of the expansion (pressure difference), on the nozzle through which the expansion is performed (abrupt or gradual pressure decline), the propellant, e.g., water, carbon dioxide etc..

Particular influential factors during foam formation are the volume of the dissolved gas as well as the expansion temperature. With very high-pressure differences during expansion and large volumes of propellants in the melted anti-microbial glass, a foam is formed which has extremely thin wall thicknesses. In this case, the foam can become so unstable that it collapses inwardly.

With the following grinding process, extremely small particles can be produced as a result of the thin wall thickness of the foam.

As a result of the preceding foaming, the follow-up grinding process is substantially easier than the crushing of large anti-microbial glass pieces.

Based on the foam formation with wall thicknesses of down to below 1 μm, particles with very small particle sizes result with conventional mills so that wet-grinding can be dispensed with under favorable conditions. As stated above, there are many anti-microbial glasses that would completely dissolve in water. For glasses with low hydrolytic durability, small particles can be produced without wet-grinding according to the method described with conventional mills.

Nevertheless, a final classification of the particles according to the individually required grain size is purposeful. In this case the larger constituents, unless these fall into an application range, are again led back to the basic material. There is no chemical change when using a suitable propellant.

Other features which are considered as characteristic for the invention are set forth in the appended claims.

Although the invention is described herein as embodied in a method for manufacturing the anti-microbial glass particles, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

In a particular embodiment of the invention, an extruder can be advantageously used for putting in the above-mentioned propellants. The required pressure in the anti-microbial glass melt is built up by an extruder worm conveyor and/or extruder worm conveyors.

The input of the propellants, such as for example water, argon gas, etc., is performed by nozzles into the melt. A mixing effect of the glass with the propellant is affected by a rotating movement of the worm conveyor and/or the work conveyors at very high pressure, whereby at the same time a conveying movement towards the outlet nozzle takes place.

Pressures of up to 500 bar and higher can be produced with an extruder. The foam formation takes place during a follow-up pressure reduction.

In a further particular embodiment of the invention, further anti-microbial additive materials are added to the extruder. These can be in particular heavy metals and/or heavy metal oxides. In this way, the anti-microbial effect can be increased further.

However, not all metals and/or metal oxides can be chemically bound into the glass melt with microbial effect in every concentration, meaning, with a conventional melting of the raw materials, only a part of the microbial effective substances would combine chemically with the glass or would dissolve in the glass. The other part would more or less be in a crystalline state and distributed in the glass. However, a homogenous distribution of the non-dissolved or chemically bound microbial effective substances does not take place in the conventional ways.

In the method according to the invention the anti-microbial effective substances, which do not bind chemically with the glass or dissolve in the glass, are homogenously distributed in the extruder, particularly in the two-worm or multiple-worm extruder, meaning, the anti-microbial effective substances are homogenously distributed like a filling material as a result of the very good mixing effect of the extruder worms in the high viscous range.

After the follow-up grinding process the non-chemically bound or dissolved anti-microbial are in the original condition (crystalline), encased in the single grains and particles, respectively. These encased anti-microbial substances can release their full effect after the dissolving of the encasement, and not before.

However, as the basic material is formed of anti-microbial glass and additionally contains embedded anti-microbial substances in crystalline form, the effect is greater as a result of the high concentration of anti-microbial substances.

If the anti-microbial effect of the glass is to be maintained over a longer period of time, a glass with a higher hydrolytic durability over a longer period of time can therefore discharge the above-mentioned heavy metal ions in the same concentration. The cause lies in the very high concentration of the heavy metals (partially crystalline and partially chemically bound or dissolved) in the glass and in the higher hydrolytic durability of the glass.

I claim:

1. A method for manufacturing anti-microbial glass particles, which comprises the steps of:
melting, breaking or pulverizing anti-microbial glasses or known substances for forming anti-microbial glasses resulting in a prepared composition of anti-microbial glass;
putting the prepared composition of anti-microbial glass in an extruder;
putting an additive selected from the group consisting of heavy metals and anti-microbial effective substances into the extruder, where the additive is melted or smelted and mixed with the prepared composition of anti-microbial glass resulting in a melted anti-microbial glass mixture; and
cooling the melted anti-microbial glass mixture resulting in an anti-microbial glass mixture, and after cooling the additive mixed in the anti-microbial glass mixture being crystalline or in an original condition, and the additive being enveloped and evenly distributed in the anti-microbial glass mixture.

2. The method according to claim 1, which further comprises grinding the anti-microbial glass mixture containing the additive in the crystalline or in the original condition and being enveloped and evenly distributed in the anti-microbial glass mixture.

3. The method according to claim 1, which further comprises foaming up the melted anti-microbial glass mixture with the addition of the additive resulting in an anti-microbial foamed glass, and, after the cooling, the additive in the anti-microbial foamed glass being in the crystalline or in the original condition and enveloped and evenly distributed in the anti-microbial foamed glass.

4. The method according to claim 3, which further comprises adding additional substances for facilitating the foaming of the melted anti-microbial glass mixture to the melted anti-microbial glass mixture having the additive present therein in the crystalline or in the original condition and enveloped and evenly distributed in the anti-microbial glass mixture.

5. The method according to claim 3, which further comprises adding gaseous substances for assisting in the foaming up of the melted anti-microbial glass mixture having the additive present therein in the crystalline or in the original condition and enveloped and evenly distributed in the anti-microbial glass mixture.

6. The method according to claim 3, which further comprises adding foam-forming substances to the melted anti-microbial glass mixture for initiating the foaming up, by a change of an aggregate condition, of the melted anti-microbial glass mixture having the additive present therein in the crystalline or in the original condition and enveloped and evenly distributed therein.

7. The method according to claim 3, which further comprises adding one of chemical compounds and chemical elements as foam-forming substances which initiate a gas formation by a chemical reaction and, subsequently, initiating the foaming of the melted anti-microbial glass mixture for foaming up the melted anti-microbial glass mixture containing the additive present in the crystalline or in the original condition and are enveloped and evenly distributed therein.

8. The method according to claim 3, which further comprises adding foam-forming substances as a solution, emulsion or mixture to the melted anti-microbial glass mixture containing the additive in the crystalline or in the original condition and enveloped by and evenly distributed in the anti-microbial glass mixture.

9. The method according to claim 3, which further comprises: treating the melted anti-microbial glass mixture with an additional additive selected from the group consisting of heavy metals and anti-microbial effective substances;
foaming up the melted anti-microbial glass mixture resulting in the anti-microbial foamed glass, and, after cooling, the additional additive in the anti-microbial foamed glass is present in crystalline or in original condition and is enveloped and evenly distributed; and
grinding up the anti-microbial foamed glass.
